(19) United States
(12) Patent Application Publication
(10) Pub. No.: US 2019/0052681 A1
(43) Pub. Date: Feb. 14, 2019

(54) SHARED TERMINAL DETECTION METHOD AND DEVICE THEREFOR

(71) Applicant: SOOSAN INT CO., LTD., Seoul (KR)

(72) Inventors: Yun-Seok Lee, Seoul (KR); Yong-Hwan Lee, Seoul (KR)

(21) Appl. No.: 15/759,072

(22) PCT Filed: Sep. 9, 2016
(86) PCT No.: PCT/KR2016/010198

§ 371 Date: Mar. 9, 2018

(30) Foreign Application Priority Data
Sep. 10, 2015 (KR) 10-2015-0128572

(51) Int. Cl. H04L 29/06; H04L 29/12; H04L 29/08; H04L 12/18

(52) U.S. Cl. CPC H04L 65/1069; H04L 65/607; H04L 12/1813; H04L 67/025; H04L 61/2571

(57) ABSTRACT

Provided are a shared terminal detection method and a device therefor. A shared terminal detection server receives web access traffic for connection of a terminal to a web server, transmits a response message for requesting reconnection to an IP detection web page describing a web real-time communication request to the terminal, and acquires a private IP address of the terminal identified by a STUN server, to detect whether the terminal is a shared terminal.

### TECHNICAL FIELD

The present disclosure relates to a method of detecting a terminal sharing a public Internet Protocol (IP) address and a device therefor, and more particularly, to a method of detecting a shared terminal by using a private IP address of a terminal and a device therefor.

### BACKGROUND ART

FIG. 1 is a diagram illustrating an example of a terminal sharing a public IP address by using a conventional internet sharer. Referring to FIG. 1, a sharer 120 converts a private IP address included in a packet received from terminals 100 and 110 into a public IP address and transmits the same to a web server 130 or the like, and converts a public IP address included in a packet received from the web server 130 into a private IP address of a terminal that is an actual destination of the packet and transmits the same to the terminals 100 and 110.

There is a method of assigning a terminal identification value by using a cookie, as a method of detecting whether a terminal shares a public IP address (i.e., a shared terminal). However, when an identification value is assigned to a terminal by using a cookie, since a user may delete a cookie or the like, there is a limitation in detecting an accurate shared terminal.

### DESCRIPTION OF EMBODIMENTS

### Technical Problem

Provided are a method capable of detecting whether a terminal is a shared terminal by easily identifying a private Internet Protocol (IP) address of the terminal without the need to install a program such as an applet for detecting a shared terminal or a cookie including a terminal identification value in the terminal and a device therefor.

### Solution to Problem

According to an aspect of the present disclosure, there is provided a method of detecting a shared terminal sharing a public IP address by a shared terminal detection server, the shared terminal detection server including: receiving web access traffic for connection of a terminal to a web server; transmitting a response message for requesting reconnection to an IP detection web page describing a web real-time communication request to the terminal in response to the web access traffic; acquiring a private IP address of the terminal identified by a Session Traversal Utilities for Network Address Translation (STUN) server for web real-time communication setting of a web browser of the terminal through the IP detection web page; and detecting whether the terminal is a shared terminal, based on the private IP address.

According to another aspect of the present disclosure, there is provided a method of detecting a terminal sharing a public IP address, the terminal including: transmitting web access traffic for connection of a web browser to a web server; receiving a response message for requesting reconnection to an IP detection web page of a shared terminal detection server in response to the web access traffic; connecting to the IP detection web page according to the response message; requesting and receiving network information from a STUN server by the web browser according to a procedure described in a script of the IP detection web page; and providing a private IP address of the terminal included in the network information to the shared terminal detection server.

### Advantageous Effects of Disclosure

According to the present disclosure, it may be possible to detect a shared terminal based on a private IP address of a terminal identified by using the Web Real-Time Communication (WebRTC) of a web browser. Also, since it is unnecessary to assign a terminal identification value through a cookie or the like or install a program such as a separate applet for detecting a shared terminal in a terminal, it may be possible to prevent shared terminal detection disturbance caused by malicious deletion of an applet or a cookie of a terminal user.

### BRIEF DESCRIPTION OF DRAWINGS

FIG. 1 is a diagram illustrating an example of a terminal sharing a public Internet Protocol (IP) address by using a conventional internet sharer.

FIG. 2 is a diagram illustrating an example of a method of identifying a local IP address by using an applet.

FIG. 3 is a diagram illustrating a schematic configuration of an entire system for detecting a shared terminal according to the present disclosure.

FIG. 4 is a flow diagram illustrating an embodiment of a method of detecting a shared terminal according to the present disclosure.

FIG. 5 is a diagram illustrating an example of an IP detection web page provided by a shared terminal detection server according to the present disclosure.

FIG. 6 is a diagram illustrating another example of an IP detection web page provided by a shared terminal detection server according to the present disclosure.

FIG. 7 is a diagram illustrating an example of an IP address stored and managed by a shared terminal detection server according to the present disclosure.

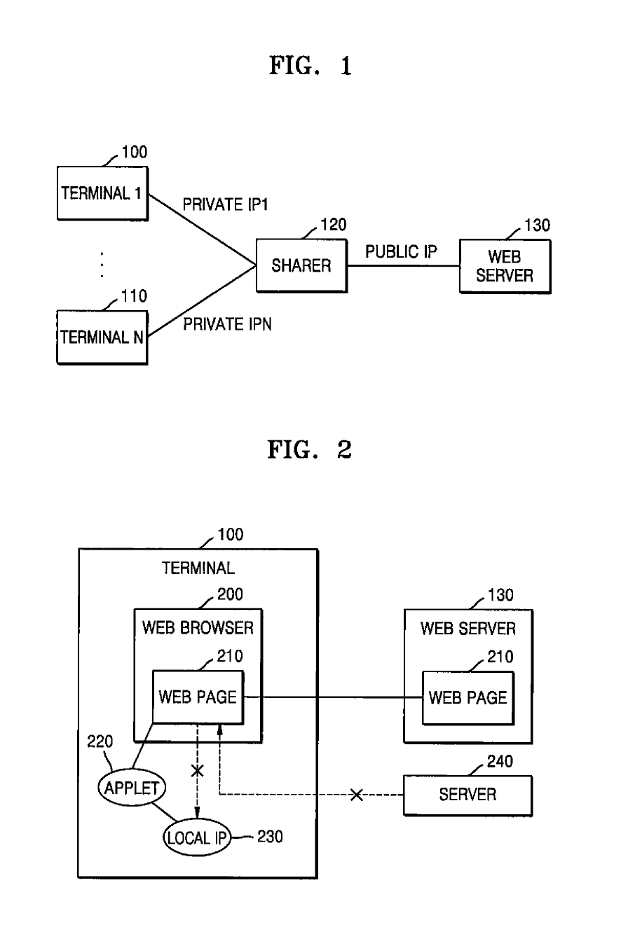

### MODE OF DISCLOSURE

Hereinafter, shared terminal detection methods and devices therefor according to the present disclosure will be described in detail with reference to the accompanying drawings.

FIG. 2 is a diagram illustrating an example of a method of identifying a local Internet Protocol (IP) address by using an applet.

Referring to FIG. 2, a terminal 100 connects to a web server 130 through a web browser 200 and downloads and displays a web page 210 including a script or the like. The web browser 200 of the terminal 100 interprets a script of the web page 210 and performs a procedure described in the script. The script constituting the web page 210 has a limitation in accessing the local resources or local information of the terminal 100 due to various problems such as security and particularly, it may not directly access a local IP address (i.e., private IP address) 230 of a terminal. Also, another server 240 may not access the web page 210 provided by the web server 130.

The web server 130 should access a separate program such as an applet 220 in order to access the local IP address 230 of the terminal. A script of a web page is a type of text set describing a procedure interpreted and processed by a web browser without compilation. On the other hand, unlike the script of the web page, the applet 220 is a type of program that is downloaded separately from the web server 130, stored in the terminal local, and performed through compilation. For example, the web server 130 may provide a separate applet 220 to the terminal and then identify the local IP address 230 of the terminal through the applet 220, but may not identify the local 1P address 230 through the script of the web page 210.

A method of identifying a local IP address of the terminal by using the applet 220 may not identify the local IP address when a user deletes the applet or refuses to install the applet. In the following embodiments, a method of detecting a shared terminal by acquiring a private IP address of a terminal without installing an applet will be described.

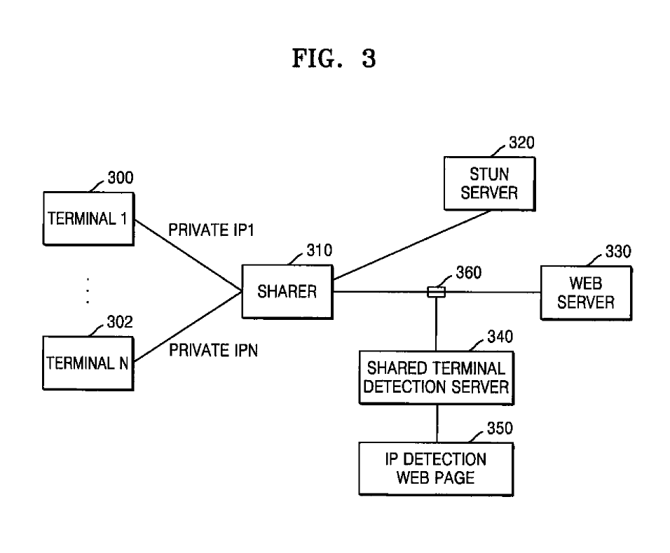

FIG. 3 is a diagram illustrating a schematic configuration of an entire system for detecting a shared terminal according to the present disclosure.

Referring to FIG. 3, there are at least two terminals 300 and 302 sharing a public IP address through a sharer 310, a shared terminal detection server 340 detecting a shared terminal, a Session Traversal Utilities for Network Address Translation (STUN) server 320 providing network information for Web Real-Time Communication (WebRTC), and the like.

The sharer 310 is a device that allows a plurality of terminals 300 and 302 to share a public IP address, such as a Network Address Translation (NAT) device. For example, the sharer 310 converts a private IP address included in a packet received from the terminals 300 and 302 into a public IP address and transmits the same to the outside, and converts a public IP address included in a packet received from the outside into a private IP address and transmits the same to the internal terminals 300 and 302.

The web server 330 is a server providing various contents or the like and may be, for example, a server providing a portal site such as ‘NAVER’. The type of the web server may vary and is not limited to any one.

In order to enable web real-time communication through the web browser of the terminal, the STUN server 320 identifies network information (e.g., a public IP address of the sharer 310 and a private IP address of the terminals 300 and 302) to which the terminals 300 and 302 belong. The terminals 300 and 302 may directly communicate data such as voice and video with other terminals by using a web browser such as Chrome, Firefox, or Opera without having to install a separate peer-to-peer (P2P) connection program, and the connection between terminals through the web browser is referred to as Web Real-Time Communication (WebRTC).

Since the web real-time communication is the connection between terminals that have not passed through a server (that is, P2P connection), it may be necessary to pre-identify whether inter-terminal communication is possible and this may be performed by a STUN server. There may be a plurality of STUN servers, and the terminal may select any one of the STUN servers 320 and request and receive network information from the selected STUN server 320, to which it belongs. The STUN server 320 may identify network information of the terminals 300 and 302 through an Interactive Connectivity Establishment (ICE) framework.

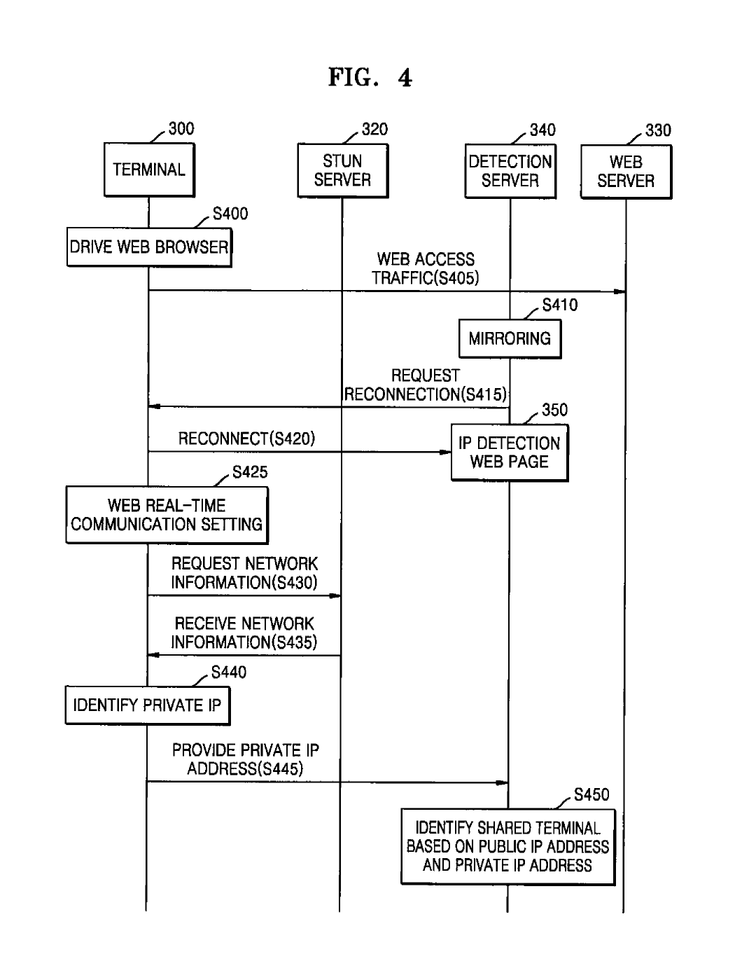

The shared terminal detection server 340 receives web access traffic transmitted from the terminals 300 and 302 to the web server 330 through mirroring of a mirroring device 360, requests the terminals 300 and 302 to reconnect to an IP detection web page 350 of the shared terminal detection server 340, and acquires the network information identified by the STUN server 320 through the IP detection web page 350 for web real-time communication of a terminal to detect whether the terminal is a shared terminal. The IP detection web page 350 may include a server-side script describing a procedure performed in the shared terminal detection server 340 and a client-side script describing a procedure performed in the terminal. A shared terminal detection process will be described in detail with reference to FIG. 4.

Although the present embodiment describes a structure in which the shared terminal detection server 340 is connected to the mirroring device 360, the present disclosure is not limited thereto and the shared terminal detection server 340 may be implemented at the position of the mirroring device 360 or may be implemented as a portion of the web server 330 or the STUN server 320.

FIG. 4 is a flow diagram illustrating an embodiment of a method of detecting a shared terminal according to the present disclosure.

Referring to FIG. 4, the terminal 300 drives a web browser capable of web real-time communication (S400), and transmits web access traffic for connection to a website (e.g., ‘Google’) input or selected by the user to the web server (S405).

The shared terminal detection server (hereinafter referred to as detection server) 340 receives the web access traffic through mirroring (S410). In response to the web access traffic, the detection server 340 transmits a response message for requesting reconnection to the IP detection web page 350 to the terminal 300 (S415). The response message may further include a reconnection request to the web server 330 to which the terminal intends to connect.

When receiving a response of the detection server 340 before a response of the web server 330, the terminal 300 reconnects to the IP detection web page 350 of the detection server 340 according to the response message of the detection server 340 (S420). When the response message includes a reconnection request to the web server to which the terminal intends to connect, the terminal 300 also reconnects to the web server 330. When receiving a response message for the web access traffic from the web server 330 after receiving the response message from the detection server 340, the terminal 300 discards the received response message.

When the terminal 300 connects to the IP detection web page 350, the web browser of the terminal 300 interprets and performs a client-side script related to the network information report and the web real-time communication setting included in the IP detection web page 350. In detail, the terminal 300 performs an initialization process such as the setting of the STUN server 320 for web real-time communication through the web browser according to the procedure described in the script of the IP detection web page 350 (S425), and requests and receives network information (public IP address, private IP address, etc.) to which the terminal itself belongs, from the STUN server 320 (S430, S435).

The terminal 300 provides the private IP address of the terminal 300 identified through the STUN server 320 to the detection server according to the procedure described in the script of the IP detection web page (S440, S445). For example, the script of the IP detection web page 350 may provide a private IP address to the detection server 340 through an active server page (ASP) function call having a private IP address as a parameter. Herein, an active server page (ASP) is a server-side script that is interpreted and performed by the detection server 340, unlike a client-side script that is interpreted and performed by the web browser of the terminal 300.

The detection server 340 detects whether the terminal is a shared terminal, based on the private IP address of the terminal received through the IP detection web page 350 (S450). For example, the detection server 340 may map and store the public IP address of the terminal 300 included in the web access traffic and the private IP address identified through the STUN server 320 and then detect whether the terminal is a shared terminal, based on the number of different private IP addresses with respect to each public IP address. As another example, the detection server 340 may receive the private IP address and the public IP address of the terminal identified by the STUN server 320 from the terminal 300 through the IP detection web page 350 and then detect whether the terminal is a shared terminal, based on the number of different private IP addresses with respect to each public IP address.

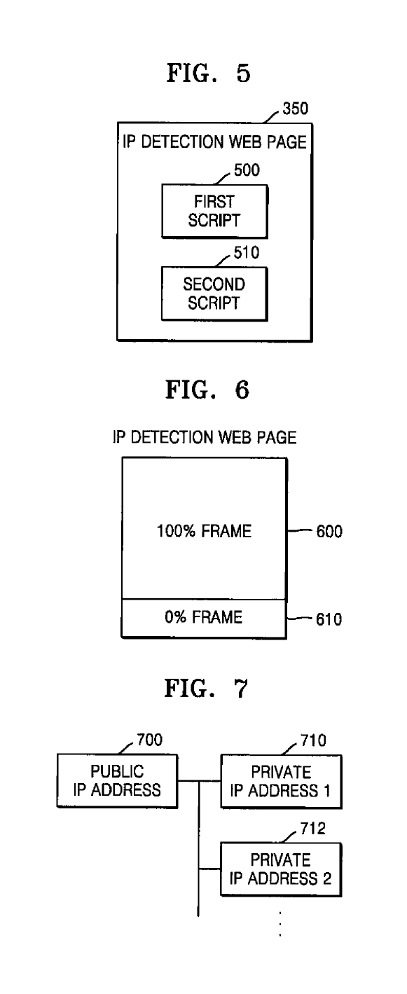

FIG. 5 is a diagram illustrating an example of an IP detection web page provided by a shared terminal detection server according to the present disclosure.

Referring to FIG. 5, the IP detection web page 350 includes a first script 500 describing a procedure of setting web real-time communication through a web browser of a terminal and a second script 510 describing a procedure of providing network information identified through a STUN server to a detection server.

The first script 500 is a client-side script including a procedure of selecting a STUN server and requesting and receiving network information from the STUN server. The web browser of the terminal may acquire network information (public IP address, private IP address, etc.) from the STUN server by performing a procedure according to the first script 500 of the IP detection web page. As illustrated in FIG. 2, a method of describing a procedure to be performed by a web browser through a script of a web page may have very limited access to the local information of the terminal, and particularly, the local IP address of the terminal may not be accessed. Thus, the present embodiment identifies the private IP address of the terminal through the STUN server that identifies and provides the network information of the terminal for web real-time communication through the web browser.

The second script 510 includes a procedure of providing the detection server with the private IP address of the terminal identified through the procedure described in the first script 500. Although the terminal may provide network information by performing another communication connection process with the detection server, the second script 510 may include a procedure of calling a server-side script (e.g., an active server page (ASP)) performed in the detection server side in order to easily provide the network information (private IP address, public IP address, etc.) identified by the STUN server through the IP detection web page. For example, the web browser of the terminal calls an ASP function having a parameter of the network information identified by the STUN server according to the procedure described in the second script 510, and the detection server detects whether the terminal is a shared terminal by mapping and storing a public IP address and a private IP address transmitted as a parameter. Thus, the present embodiment may not require a separate applet for detecting a private IP address.

FIG. 6 is a diagram illustrating another example of an IP detection web page provided by a shared terminal detection server according to the present disclosure.

Referring to FIG. 6, the IP detection web page may include frames of various sizes (more than 0% and less than 100%) such as a 100% frame 600 or a 0% frame 610. The 100% frame 600 refers to a frame that is displayed in 100% size on a web browser of the terminal, and the 0% frame 610 refers to a 0-sized frame that is not displayed on the web browser.

FIG. 7 is a diagram illustrating an example of an IP address stored and managed by a shared terminal detection server according to the present disclosure.

Referring to FIG. 7, the detection server maps, stores, and manages a public IP address 700 and private IP addresses 710 and 712. The detection server may identify the number of terminals sharing the public IP address based on the number of private IP addresses 710 and 712 with respect to each public IP address 700.

The detection server may identify the public IP address 700 included in the web access traffic transmitted to the web server by the terminal and receive the private IP addresses 710 and 712 from the terminal through the IP detection web page or receive the private IP addresses 710 and 712 and the public IP address 700 from the terminal through the IP detection web page.

The present disclosure may also be embodied as computer-readable codes on a computer-readable recording medium. The computer-readable recording medium may be any data storage device that may store data that may be thereafter read by a computer system. Examples of the computer-readable recording medium may include read-only memories (ROMs), random-access memories (RAMs), compact disk read-only memories (CD-ROMs), magnetic tapes, floppy disks, and optical data storage devices. The computer-readable recording medium may also be distributed over network-coupled computer systems so that the computer-readable codes may be stored and executed in a distributed fashion.

The present disclosure has been particularly shown and described with reference to the embodiments thereof. However, those of ordinary skill in the art will understand that various changes in form and details may be made therein without departing from the spirit and scope of the present disclosure as defined by the appended claims. Therefore, the described embodiments should be considered in descriptive sense only and not for purposes of limitation. Thus, the scope of the present disclosure may be defined not by the above descriptions but by the appended claims, and all differences within the equivalent scope thereof will be construed as being included in the present disclosure.

1. A method of detecting a shared terminal sharing a public Internet Protocol (IP) address by a shared terminal detection server, the shared terminal detection server comprising:
receiving web access traffic for connection of a terminal to a web server;
transmitting a response message for requesting reconnection to an IP detection web page describing a web real-time communication request to the terminal in response to the web access traffic;
acquiring a private IP address of the terminal identified by a Session Traversal Utilities for Network Address Translation (STUN) server for web real-time communication setting of a web browser of the terminal through the IP detection web page; and
detecting whether the terminal is a shared terminal, based on the private IP address.

2. The method of claim 1, wherein the IP detection web page comprises a 0% frame.

3. The method of claim 1, wherein the web browser of the terminal requests and receives network information of the terminal from the STUN server according to a script described in the IP detection web page.

4. The method of claim 1, wherein the IP detection web page comprises:
a first script for requesting and receiving network information of the terminal from the STUN server for web real-time communication through the web browser of the terminal; and
a second script for calling an active server page with a parameter of a private IP address of the terminal included in the network information.

5. The method of claim 1, wherein a terminal reconnected to the IP detection web page comprises:
calling a web real-time communication Application Program Interface (API) defined in a web browser;
requesting and receiving network information from a STUN server;
identifying a private IP address of the terminal included in the network information; and
providing the private IP address to the shared terminal detection server.

6. A method of detecting a terminal sharing a public Internet Protocol (IP) address, the terminal comprising:
transmitting web access traffic for connection of a web browser to a web server;
receiving a response message for requesting reconnection to an IP detection web page of a shared terminal detection server in response to the web access traffic;
connecting to the IP detection web page according to the response message;
requesting and receiving network information from a Session Traversal Utilities for Network Address Translation (STUN) server by the web browser according to a procedure described in a script of the IP detection web page; and
providing a private IP address of the terminal included in the network information to the shared terminal detection server.

7. A computer-readable recording medium having a program recorded thereon for performing the method of claim 1.
